(19) United States
(12) Patent Application Publication
(10) Pub. No.: US 2020/0010086 A1
(43) Pub. Date: Jan. 9, 2020

(54) SYSTEM AND METHOD FOR ACTIVE THERMAL MANAGEMENT

(71) Applicant: Dr. Ing. h.c. F. Porsche Aktiengesellschaft, Stuttgart (DE)

(72) Inventors: Björn Pehnert, Tamm (DE); Patrik Gisch, Heimsheim (DE)

(73) Assignee: Dr. Ing. h.c. F. Porsche Aktiengesellschaft, Stuttgart (DE)

(21) Appl. No.: 16/444,065

(22) Filed: Jun. 18, 2019

(30) Foreign Application Priority Data
Jul. 6, 2018 (DE) 102018116439.4

(51) Int. Cl. B60W 30/18

(52) U.S. Cl. CPC B60W 30/18; G05D 1/0088

(57) ABSTRACT

A thermal management system for active thermal management of an autonomously operable motor vehicle. In order to further improve the energy efficiency during operation of an active thermal management system, in an autonomous driving operation, controllable drive components are incorporated in the thermal management system in terms of temperature control in such a way that the drive components are operated in a maximally efficient temperature range.

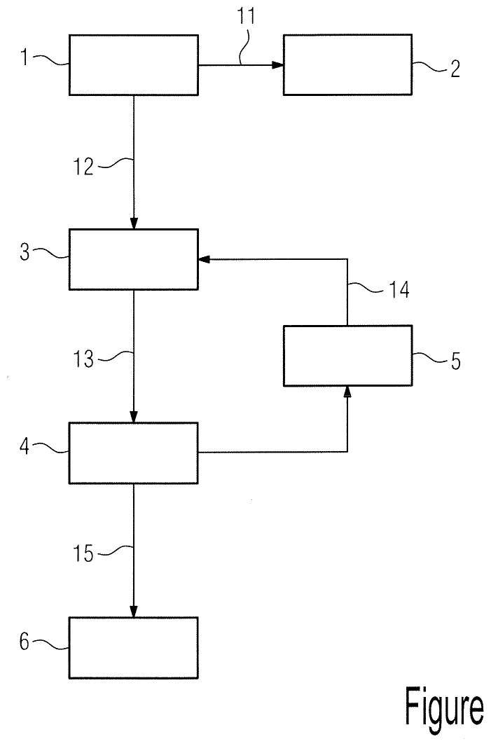

### CROSS-REFERENCE TO RELATED APPLICATION

This application claims priority to German Patent application No. DE 10 2018 116 439.4, filed Jul. 6, 2018, which is incorporated by reference herein in its entirety.

### FIELD OF THE INVENTION

The invention relates to a system and a method for active thermal management of an autonomously operable motor vehicle.

### BACKGROUND OF THE INVENTION

German laid-open specification DE 10 2016 224 149 A1, which is incorporated by reference herein, discloses a method for displaying a distance to empty, wherein for a set destination a distance to empty DTE is calculated both for the autonomous and the driver driving mode, and a driving mode of the vehicle can be selected on the basis of the DTE. German laid-open specification DE 10 2016 116 846 A1, which is incorporated by reference herein, discloses a method for processing an input of one or more factors, for example driving style of the driver, topographical conditions, air conditioning settings, outside temperature, which have an influence on the power output of the vehicle, and the determination of a change in the range to be expected and/or fuel efficiency on the basis of a change of these factors. American laid-open specification US 2017/0369010 A1, which is incorporated by reference herein, discloses a system for a vehicle in which, in the event of a low gas or battery level, energy conservation measures can be selected and implemented, wherein the selection and implementation can also be carried out autonomously. From American patent U.S. Pat. No. 9,579,949 B2, which is incorporated by reference herein, it is known to regulate the power output of an HVAC system of an autonomous or driver-controlled vehicle on the basis of a power-saving plan, wherein the regulation is carried out as a function of the distance to the destination.

### SUMMARY OF THE INVENTION

Described herein is an improvement to the power efficiency in the operation of an autonomously operable motor vehicle having an active thermal management system.

In a thermal management system for active thermal management of an autonomously operable motor vehicle, the object is achieved in that in an autonomous vehicle operation controllable drive components, in particular all controllable drive components, are incorporated in the thermal management system in terms of temperature control in such a way that the drive components, in particular all drive components, are operated in a maximally efficient temperature range. As a result, in a simple manner, energy-efficient and comfortable travel of the autonomously operated motor vehicle is made possible. At the same time, the outlay needed for the thermal management can be reduced to a minimum.

In a thermal management system for active thermal management of an autonomously operable motor vehicle, controllable vehicle components, such as adjustable spoilers, fans, pumps and/or cooling flaps, are incorporated in the thermal management system in terms of temperature control. As a result, in a simple way, particularly efficient operation in the autonomous driving operation of the motor vehicle is made possible.

In a method for operating an autonomously operable motor vehicle having a thermal management system, in particular having a thermal management system described previously, the object indicated above is alternatively or additionally achieved in that in an autonomous driving operation the thermal management system is controlled autonomously together with controllable vehicle components, in particular with all controllable vehicle components, with regard to a planned driving style. Advantageously, both during a time-optimal autonomous journey and also in a range-optimal autonomous journey, driving strategy recommendations are transmitted from the thermal management system to a driving manager, in order to travel range-optimally or comfort-optimally in the autonomous driving mode. In the autonomous driving operation, the driver of the motor vehicle usually has no focus on the exact driving speed. Thus, the action by a thermal management function can be made possible without any losses of driver impression or similar topics.

A further preferred exemplary embodiment of the method is characterized in that the controllable vehicle components comprise controllable drive components which, in autonomous driving operation, are controlled, in particular regulated, autonomously by the thermal management system in such a way that the controllable drive components are operated in a maximally efficient temperature range with regard to the planned driving style in the autonomous driving operation. As a result, a desired destination can advantageously be reached comfortably with minimum expenditure of energy.

A further preferred exemplary embodiment of the method is characterized in that the controllable vehicle components comprise adjustable spoilers, fans, pumps and/or cooling flaps. If the motor vehicle is in the autonomous driving mode, thermal management software calculates optimum settings for the controllable vehicle components for the planned route, depending on the planned driving style, in order to permit energy-efficient and comfortable travel.

A further preferred exemplary embodiment method is characterized in that in the autonomous driving operation the controllable vehicle components are set optimally in control terms in the thermal management system with regard to the planned driving style. The aim of the function is to run all controllable vehicle components, in particular all drive components, in the optimal temperature range and to reduce that outlay which is needed for the thermal management to a minimum.

A further preferred exemplary embodiment of the method is characterized in that the planned driving style in the autonomous driving operation comprises a planned vehicle speed, a planned vehicle acceleration and/or a planned route selection. The planned driving style in the autonomous driving operation advantageously comprises both a planned vehicle speed, a planned vehicle acceleration and also a planned route selection.

A further preferred exemplary embodiment of the method is characterized in that temperatures of at least one controllable vehicle component, in particular of multiple or all controllable vehicle components, are calculated in advance for the planned driving style in the autonomous driving operation, wherein the planned driving style is adapted as a function of an overshoot to be expected of an optimal temperature of the at least one controllable vehicle component. If no overshoot of the optimal temperature is to be expected, the vehicle is operated in the autonomous driving operation with the planned driving style.

The invention further relates to a computer program product having program code for carrying out a previously described method. The computer program product is, for example, thermal management software which, in the autonomous driving mode, calculates optimum settings for the controllable vehicle components in coordination with the planned driving style.

The invention further relates to a control system having such a computer program product. The invention optionally also relates to a motor vehicle having such a control system.

### BRIEF DESCRIPTION OF THE DRAWING

Further advantages, features and details of the invention emerge from the following description, in which, with reference to the drawing, various exemplary embodiments are described in detail.

The sole figure shows a flowchart to illustrate the operation of an autonomously operable motor vehicle having a thermal management system.

### DETAILED DESCRIPTION OF THE INVENTION

The figure shows a flowchart having six rectangles 1 to 6 and five arrows 11 to 15. The rectangle 1 represents an autonomous driving operation of a motor vehicle which is equipped with a thermal management system. The arrow 11 represents the fact that the motor vehicle is not to be operated autonomously. The rectangle 2 indicates that the motor vehicle is driven freely, that is to say operated by a driver.

The arrow 12 indicates that the vehicle is to be operated autonomously. In a rectangle 3, temperatures for a planned driving time are calculated autonomously in advance in the autonomous driving operation. The arrow 13 indicates that thermal management software checks whether, within the context of the planned driving time in the autonomous driving operation with a planned driving style, an overshoot of an optimal temperature of a controllable vehicle component is likely.

If a temperature overshoot is to be expected, adaptation of a planned acceleration and speed profile is performed by means of the thermal management system, as indicated by the rectangle 5.

The arrow 14 indicates that the temperatures for the planned driving time are calculated in advance once more in the autonomous driving operation. If no temperature overshoot is then predicted, the route is travelled autonomously in accordance with the plan, as indicated by the arrow 15 and the rectangle 6.

The thermal management software calculates optimal settings of, for example, spoilers, fans, pumps and cooling air flaps for the planned route when the vehicle is in the autonomous driving mode. A planned driving style for an energy-efficient and comfortable journey is taken into account by the thermal management software. The planned driving style is adapted if necessary.

The plan is to run all the drive components in the optimal temperature range and in the process to reduce that outlay which is necessary for the thermal management to a minimum. It may be, for example, that during an autonomous journey, a small change in the driving strategy, in particular in view of the speed of the motor vehicle or a call for power, leads to an increase in the driving efficiency.

If, for example, it is detected during an autonomous journey that, given a reduction in the speed by 10 km/h, the cooling air flaps and the fans can remain switched off completely as far as the planned journey's end, then the thermal management system transmits a corresponding request for speed reduction to a driving strategy manager in the motor vehicle, in order to arrive most efficiently at the destination.

In addition, to assess usefulness and expenditure in the driving strategy manager, a forecast range saving can be calculated and transmitted, in order to assess whether application of the planned thermal management strategy is expedient or not expedient.

What is claimed is:

1. A thermal management system for active thermal management of an autonomously operable motor vehicle, said thermal management system comprising controllable drive components that are incorporated in the thermal management system in such a way that the controllable drive components are operated in either a maximally efficient or predetermined temperature range in an autonomous vehicle operation.

2. The thermal management system as claimed in claim 1, wherein the controllable vehicle components are adjustable spoilers, fans, pumps and/or cooling flaps.

3. A method for operating an autonomously operable motor vehicle having a thermal management system, the method comprising:
autonomously controlling the thermal management system together with controllable vehicle components with regard to a planned driving style in an autonomous driving operation of the motor vehicle.

4. The method as claimed in claim 3, wherein the controllable vehicle components comprise controllable drive components which, in the autonomous driving operation, are autonomously controlled and regulated by the thermal management system in such a way that the controllable drive components are operated in either a predetermined or a maximally efficient temperature range with regard to the planned driving style in the autonomous driving operation.

5. The method as claimed in claim 3, wherein the controllable vehicle components comprise adjustable spoilers, fans, pumps and/or cooling flaps.

6. The method as claimed in claim 3, wherein in the autonomous driving operation, the controllable vehicle components are set optimally in control terms in the thermal management system with regard to the planned driving style.

7. The method as claimed in claim 3, wherein the planned driving style in the autonomous driving operation comprises a planned vehicle speed, a planned vehicle acceleration and/or a planned route selection.

8. The method as claimed in claim 3, wherein the temperature of at least one controllable vehicle component is calculated in advance for the planned driving style in the autonomous vehicle operation, wherein the planned driving style is adapted as a function of an overshoot to be expected of an optimal temperature of the at least one controllable vehicle component.

9. A computer program product having program code configured for carrying out a method for operating an autonomously operable motor vehicle having a thermal management system, the method comprising autonomously controlling the thermal management system together with controllable vehicle components with regard to a planned driving style in an autonomous driving operation of the motor vehicle.

10. A control system having the computer program product as claimed in claim 9.
